(19) United States
(12) Patent Application Publication
(10) Pub. No.: US 2026/0318460 A1
(43) Pub. Date: Oct. 15, 2026

(54) JACKET HEATER, JACKET HEATER MANUFACTURING METHOD, AND HEAT INSULATION STRUCTURE

(71) Applicant: NICHIAS CORPORATION, Tokyo (JP)

(72) Inventors: Akira SASAKI, Tokyo (JP); Keiichi FUKUDA, Tokyo (JP); Hiroki OOTAKE, Tokyo (JP); Hiromu SATO, Tokyo (JP)

(73) Assignee: NICHIAS CORPORATION, Tokyo (JP)

(21) Appl. No.: 19/156,927

(22) PCT Filed: Feb. 22, 2024
(86) PCT No.: PCT/JP2024/006578

§ 371 Date: Aug. 15, 2025

(30) Foreign Application Priority Data
Feb. 24, 2023 (JP) 2023-027332

(51) Int. Cl. F16L 53/35; F16L 59/08; F16L 59/147

(52) U.S. Cl. CPC F16L 53/35; F16L 59/08; F16L 59/147

(57) ABSTRACT

A jacket heater includes: a first heat insulating layer; a reflective layer arranged on an outside of the first heat insulating layer; a second heat insulating layer arranged on an outside of the reflective layer; and a heater wire arranged on an inner side of the first heat insulating layer. Accordingly, a pipe can be sufficiently heated while reducing power consumption.

### TECHNICAL FIELD

The present invention relates to a jacket heater that covers a pipe, a method of manufacturing a jacket heater, and a heat insulating structure.

### BACKGROUND ART

A pipe is covered with a jacket heater in some cases in order to prevent a gas from condensing and precipitating inside the pipe. Various gases are used in a film forming step, an etching step, and other steps in manufacture of semiconductor devices, for example. A jacket heater is sometimes used to prevent those gases from condensing and precipitating inside the pipe. An example of such a jacket heater is disclosed in Patent Literature 1.

### CITATION LIST

### Patent Literature

[PTL 1] WO 2011/126051 A1

### SUMMARY OF INVENTION

### Technical Problem

Reducing power consumption in manufacturing facilities is important for manufacturing cost, environmental impact, and the like. Accordingly, also for the jacket heater, it is required to reduce power consumption. It is possible to reduce power consumption by increasing a thickness of a heat insulating layer of the jacket heater. However, increasing the thickness of the heat insulating layer requires a larger space around the pipe for installing the jacket heater. Therefore, increasing the thickness of the heat insulating layer in order to reduce power consumption is not desired in some cases.

### Solution to Problem

A jacket heater proposed in the present disclosure is a jacket heater which is configured to be mounted to an outer periphery of a pipe, the jacket heater including: a first heat insulating layer; a reflective layer arranged on an outside of the first heat insulating layer; a second heat insulating layer arranged on an outside of the reflective layer; and a heater wire arranged on an inner side of the first heat insulating layer. This jacket heater includes the reflective layer, and hence power consumption in the jacket heater is reduced and the pipe is sufficiently heated. Further, the second heat insulating layer is provided on the outside of the reflective layer, and hence an outer surface of the jacket heater can be lowered to an appropriate temperature. As a result, workability around the jacket heater can be improved.

A method of manufacturing a jacket heater, which is proposed in the present disclosure, includes: sewing together a first heat insulating layer for covering a heater wire, a reflective layer for covering an outside of the first heat insulating layer, and a second heat insulating layer for covering an outside of the reflective layer; and sewing the heater wire onto the first heat insulating layer. With the jacket heater manufactured by this method, power consumption in the jacket heater is reduced and the pipe is sufficiently heated. Further, the second heat insulating layer is provided on the outside of the reflective layer, and hence the outer surface of the jacket heater can be lowered to an appropriate temperature. As a result, workability around the jacket heater can be improved.

A heat insulating structure proposed in the present disclosure is a heat insulating structure which is configured to be mounted to an outer periphery of a pipe, the heat insulating structure including: a first heat insulating layer; a reflective layer arranged on an outside of the first heat insulating layer; a second heat insulating layer arranged on an outside of the reflective layer; and a heater wire arranged on an inner side of the first heat insulating layer. With this heat insulating structure, power consumption in the heater wire is reduced and the pipe is sufficiently heated. Further, the second heat insulating layer is provided on the outside of the reflective layer, and hence an outer surface of the heat insulating structure can be lowered to an appropriate temperature. As a result, workability around the jacket heater can be improved.

### BRIEF DESCRIPTION OF DRAWINGS

FIG. 1 is a sectional view for illustrating a state in which a jacket heater proposed in the present disclosure is mounted to a pipe.

FIG. 2 is a sectional view taken along the line II-II of FIG. 1.

FIG. 3A is a diagram for explaining an example of stitching around a third sensor passage hole formed in the reflective layer, and is a schematic view showing the configuration as seen from the reflective layer side toward the first insulation layer in the thickness direction of the jacket heater.

FIG. 3B is a diagram for explaining another example of stitching around the third sensor passage hole formed in the reflective layer, and is a schematic view showing the configuration as seen from the reflective layer side toward the first insulation layer in the thickness direction of the jacket heater.

FIG. 4 is a perspective view for illustrating another example of the passage hole formed in the reflective layer.

### DESCRIPTION OF EMBODIMENTS

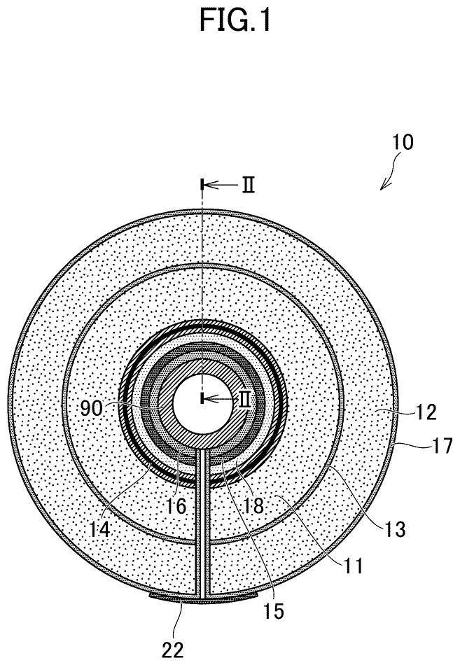

A jacket heater proposed in the present disclosure will be described below. In this specification, as an example, a jacket heater 10 shown in FIG. 1 and the like will be described.

As shown in FIG. 1, the jacket heater 10 covers the pipe 90. The jacket heater 10 heats the pipe 90, to thereby prevent the gas flowing inside the pipe 90 from condensing or precipitating.

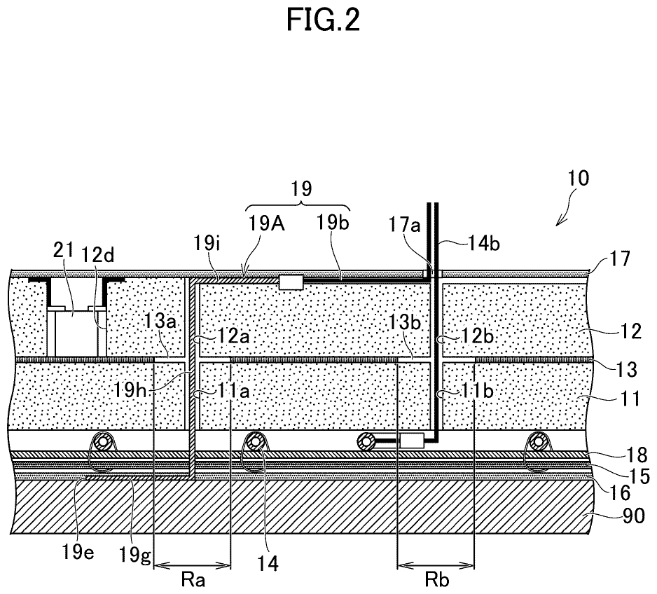

As illustrated in FIG. 2, the jacket heater 10 includes a heater wire 14 and a heater wire base material 18 on which the heater wire 14 has been mounted. The heater wire 14 is, for example, a nickel-chromium-based metallic resistor. As the heater wire base material 18, an inorganic fiber cloth made of inorganic fibers such as glass fibers, silica fibers, alumina fibers, and silica-alumina fibers can be used. The heater wire 14 is sewn onto the heater wire base material 18. The heater wire 14 is connected to an external power supply through a lead wire 14b.

As illustrated in FIG. 2, the jacket heater 10 includes a first heat insulating layer 11 and a second heat insulating layer 12. The first heat insulating layer 11 is arranged on an outer side of the heater wire 14 and the heater wire base material 18, covering them. The second insulation layer 12 is disposed further outside the first insulation layer 11, covering the first insulation layer 11.

The first heat insulating layer 11 and the second heat insulating layer 12 are each formed of, for example, a heat insulating material made of inorganic fibers. The inorganic fibers may be, for example, glass fibers, ceramic fibers, and silica fibers. Alternatively, the first insulating layer 11 and the second insulating layer 12 may be made of other inorganic or organic insulating material that contains polyimide or silica and has voids with an average width below a certain mean width of void (for example, an average width smaller than the mean free path of air molecules). The first heat insulating layer 11 and the second heat insulating layer 12 may be made of the same material or different materials.

The first heat insulating layer 11 may include one layer, or may include a plurality of superposed layers. Similarly, the second heat insulating layer 12 may include one layer, or may include a plurality of superposed layers. When each of the heat insulating layers 11 and 12 includes a plurality of layers, the plurality of layers may be made of the same material or different materials.

A thickness of the first heat insulating layer 11 may be, for example, from 5 mm to 100 mm. A thickness of the second heat insulating layer 12 may also be from 5 mm to 100 mm. Such thicknesses can ensure heat insulating performance while reducing a space required for installing the jacket heater 10. The thickness of the first heat insulating layer 11 may preferably be from 5 mm to 50 mm. More preferably, the thickness of the first heat insulating layer 11 may be from 8 mm to 30 mm. The thickness of the second heat insulating layer 12 may also preferably be from 5 mm to 50 mm. More preferably, the thickness of the second heat insulating layer 12 may be from 8 mm to 30 mm.

As illustrated in FIG. 2, the jacket heater 10 includes a reflective layer 13 disposed between the first heat insulating layer 11 and the second heat insulating layer 12. According to this configuration, heat (electromagnetic waves) emitted from the pipe 90 and the heater wire 14 is reflected by the reflective layer 13. As a result, the pipe 90 is efficiently heated. Further, the second heat insulating layer 12 is provided on the outside of the reflective layer 13, and hence an outer surface of the jacket heater 10 can be lowered to an appropriate temperature. As a result, workability around the jacket heater 10 can be improved.

It is desired that the reflective layer 13 be made of a material having high reflectivity to infrared radiation. The material of the reflective layer 13 is, for example, metal. Aluminum is a suitable material for the reflective layer 13, but other kinds of metal such as copper and stainless steel may also be used for the reflective layer 13. Further, the reflective layer 13 may be made of a material other than metal, such as ceramics, silicon carbide, or zirconia.

The reflective layer 13 is, for example, a metal foil having a thickness of from 10 μm to 700 μm. This thickness can prevent unintentional breakage of the reflective layer 13 while maintaining flexibility of the reflective layer 13. The thickness of the reflective layer 13 is preferably from 10 μm to 200 μm.

As illustrated in FIG. 1, the reflective layer 13 may be formed substantially over the entire periphery of the pipe 90. That is, the reflective layer 13 may surround the pipe 90 substantially over 360 degrees. Further, the reflective layer 13 may be provided substantially over the entirety of the jacket heater 10 in a length direction of the pipe 90.

As illustrated in FIG. 2, the jacket heater 10 includes an inner cover 16 provided on an inner side of the heater wire base material 18. An insulation layer 15 for reliably insulating the heater wire 14 and the pipe 90 from each other may be arranged between the inner cover 16 and the heater wire base material 18. Further, the jacket heater 10 includes an outer cover 17 that covers the outside of the second heat insulating layer 12.

For example, a heat-resistant sheet (including a cloth) can be used as the outer cover 17 and the inner cover 16. The outer cover 17 and the inner cover 16 may be made of the same material or different materials. For example, a porous sheet, an inorganic fiber sheet, and a resin sheet can be used as the outer cover 17 and the inner cover 16. Examples of the porous sheet can include a polytetrafluoroethylene (PTFE) sheet. Examples of the inorganic fiber sheet can include a glass cloth. The resin sheet is, for example, a fluororesin sheet. Further, the inorganic fiber sheet may be coated with a silicone or fluorine coating.

The jacket heater 10 is flexible. That is, each of the heat insulating layers 11 and 12, the reflective layer 13, the outer cover 17, the inner cover 16, the heater wire 14, and the heater wire base material 18 that form the jacket heater 10 is flexible. In a step of installing the jacket heater 10, the jacket heater 10 is wrapped around the outside of the pipe 90 and thus becomes tubular.

The jacket heater 10 includes a fixing member that fixes the jacket heater 10 under a state in which the jacket heater 10 has been wrapped around the pipe 90. The jacket heater 10 includes, as the fixing member, for example, a plurality of hook-and-loop fasteners 22 (see FIG. 1) that are aligned along one edge of the jacket heater 10. The hook-and-loop fasteners 22 may be mounted to an outer surface of the jacket heater 10. The hook-and-loop fasteners 22 are attached to an opposite edge of the jacket heater 10 under a state in which the jacket heater 10 has been wrapped around the pipe 90. The fixing member is not limited to the hook-and-loop fastener 22. The fixing member may be formed of, for example, a hook, or may include a belt that is wrapped around the outside of the jacket heater 10.

### Lead Wire Passage Hole

As illustrated in FIG. 2, a first lead wire passage hole 11b is formed in the first heat insulating layer 11. A second lead wire passage hole 12b is formed in the second heat insulating layer 12. A third lead wire passage hole 13b is formed in the reflective layer 13. The lead wire passage holes 11b, 12b, and 13b extend through the heat insulating layers 11 and 12 and the reflective layer 13, respectively, in a thickness direction of those layers. The positions of the first lead wire passage hole 11b, the second lead wire passage hole 12b, and the third lead wire passage hole 13b may be substantially the same in the length direction and a circumferential direction of the pipe 90. That is, when the jacket heater 10 is seen in the thickness direction, a part of the second lead wire passage hole 12b and a part of the third lead wire passage hole 13b may overlap the first lead wire passage hole 11b. The first lead wire passage hole 11b, the second lead wire passage hole 12b, and the third lead wire passage hole 13b may form a single passage hole extending in the thickness direction of the jacket heater 10.

As illustrated in FIG. 2, the lead wire 14b is connected to the heater wire 14. The lead wire 14b extends from the heater wire 14 through the first lead wire passage hole 11b, the third lead wire passage hole 13b, and the second lead wire passage hole 12b to the outer side of the second heat insulating layer 12.

The lead wire 14b may pass through an opening 17a formed in the outer cover 17 to extend to the outer side of the jacket heater 10. The heater wire 14 may be connected to the external power supply (controller that controls a current to be supplied to the heater wire 14) through the lead wire 14b. In the example illustrated in FIG. 2, the lead wire 14b passes through the opening 17a penetrating the outer cover 17 in the thickness direction of the outer cover 17 (radial direction of the pipe 90), to extend to the outer side of the jacket heater 10. Unlike this configuration, the lead wire 14b may extend to the outer side of the jacket heater 10 through a gap formed in an edge of the outer cover 17.

Two lead wires 14b may be connected to the heater wire 14. The two lead wires 14b may pass through the common lead wire passage holes 11b, 12b, and 13b in the order described here, and may extend to the outside of the second insulation layer 12. Unlike this configuration, the lead wire passage holes 11b, 12b, and 13b may be formed for each of the two lead wires 14b. That is, the lead wire passage holes 11b, 12b, and 13b through which the first lead wire 14b passes may be formed in the first heat insulating layer 11, the second heat insulating layer 12, and the reflective layer 13, respectively. Further, the lead wire passage holes 11b, 12b, and 13b through which the second lead wire 14b passes may be formed in the first heat insulating layer 11, the second heat insulating layer 12, and the reflective layer 13, respectively.

The third lead wire passage hole 13b may be formed inside an outer peripheral edge of the reflective layer 13. That is, an inner edge of the third lead wire passage hole 13b may have an annular shape surrounding the lead wire 14b. Similarly, the first lead wire passage hole 11b and the second lead wire passage hole 12b may be formed inside an outer peripheral edge of the heat insulating layer 11 and an outer peripheral edge of the heat insulating layer 12, respectively. That is, inner edges of the first lead wire passage hole 11b and the second lead wire passage hole 12b may each have an annular shape surrounding the lead wire 14b.

Unlike this configuration, the third lead wire passage hole 13b may be a recess formed in the outer peripheral edge of the reflective layer 13. Similarly, the first lead wire passage hole 11b and the second lead wire passage hole 12b may be recesses formed in the outer peripheral edge of the heat insulating layer 11 and the outer peripheral edge of the heat insulating layer 12. The positions of those recesses may be substantially the same in the length direction and the circumferential direction of the pipe 90.

A size of the third lead wire passage hole 13b is larger than a size of each of the first lead wire passage hole 11b and the second lead wire passage hole 12b. Specifically, a diameter Rb of the third lead wire passage hole 13b (see FIG. 2) is larger than a diameter of each of the first lead wire passage hole 11b and the second lead wire passage hole 12b. According to this configuration, a position change of the lead wire 14b inside the third lead wire passage hole 13b is limited by the lead wire passage holes 11b and 12b. As a result, contact between the lead wire 14b and the reflective layer 13 is prevented. This can prevent the reflective layer 13 from being charged due to the current from the lead wire 14b to the reflective layer 13 even when, for example, an outer sheath of the lead wire 14b is broken.

When the lead wire passage holes 11b, 12b, and 13b are circular, the size of each of the lead wire passage holes 11b, 12b, and 13b may mean the diameter of the passage hole. When the lead wire passage holes 11b, 12b, and 13b are rectangular, the size of each of the lead wire passage holes 11b, 12b, and 13b may be a width of one of inner edges of the passage hole. The first lead wire passage hole 11b and the second lead wire passage hole 12b may be centered in the third lead wire passage hole 13b.

Unlike the example illustrated in FIG. 2, the diameter Rb of the third lead wire passage hole 13b may be larger than the diameter of one of the two lead wire passage holes 11b and 12b, and may be equal to or smaller than the diameter of the other one of the lead wire passage holes 11b and 12b. For example, the diameter Rb of the third lead wire passage hole 13b may be larger than the diameter of the first lead wire passage hole 11b, and may be equal to or smaller than the diameter of the second lead wire passage hole 12b. Also in this case, the position change of the lead wire 14b inside the third lead wire passage hole 13b is limited by the first lead wire passage hole 11b.

The shape of the third lead wire passage hole 13b may be, for example, rectangular. In this case, the width of one of the inner edges of the third lead wire passage hole 13b may be larger than the width of one of the inner edges of each of the lead wire passage holes 11b and 12b.

The diameters of the lead wire passage holes 11b and 12b formed in the heat insulating layers 11 and 12 may correspond to the thickness of the lead wire 14b. In other words, the inner surfaces of the heat insulating layers 11 and 12 may be in contact with the lead wire 14b. According to this configuration, the position change of the lead wire 14b inside the third lead wire passage hole 13b is more effectively prevented.

The diameter of the first lead wire passage hole 11b and the diameter of the second lead wire passage hole 12b may be different from each other. For example, the diameter of the first lead wire passage hole 11b may correspond to the thickness of the lead wire 14b, with the inner surface of the first lead wire passage hole 11b being in contact with the lead wire 14b, while the diameter of the second lead wire passage hole 12b may be larger than the thickness of the lead wire 14b (in this case, the diameter of the first lead wire passage hole 11b). This can facilitate a process of passing the lead wire 14b through the second lead wire passage hole 12b. The relationship between the sizes of the lead wire passage holes 11b and 12b may be reverse to the example described here.

It is desired that a distance of 3 mm or more be ensured from the inner edges of the lead wire passage holes 11b and 12b to the inner edge of the third lead wire passage hole 13 b. It is further desired to ensure that this distance is 5 mm or more. According to this configuration, contact between the lead wire 14b and the reflective layer 13 can be effectively prevented.

### Sensor Passage Hole

As illustrated in FIG. 2, the jacket heater 10 includes a sensor 19. The sensor 19 includes a temperature sensing element 19A. The sensor 19 is specifically a thermocouple. In this case, the temperature sensing element 19A is a portion that includes two element wires (not shown) provided therein and made of different materials. The temperature sensing element 19A holds the two element wires insulated from each other. The temperature sensing element 19A includes a sheath formed on a surface of the temperature sensing element 19A and made of metal, and the element wires may be arranged inside the sheath. The temperature sensing element 19A may include three or more element wires.

A tip 19e of the temperature sensing element 19A is located on an inner side of the first heat insulating layer 11. The tip 19e of the temperature sensing element 19A is exposed on the inside of the inner cover 16, and may be in direct contact with the outer surface of the pipe 90. The sensor 19 includes a lead wire 19b, and may be connected to an external device (for example, a controller that controls a current to be supplied to the heater wire 14) through the lead wire 19b.

As illustrated in FIG. 2, a first sensor passage hole 11a is formed in the first heat insulating layer 11. A second sensor passage hole 12a is formed in the second heat insulating layer 12. A third sensor passage hole 13a is formed in the reflective layer 13. The sensor passage holes 11a, 12a, and 13a extend through the heat insulating layers 11 and 12 and the reflective layer 13, respectively, in a thickness direction of those layers. The positions of the first sensor passage hole 11a, the second sensor passage hole 12a, and the third sensor passage hole 13a may be substantially the same in the length direction and the circumferential direction of the pipe 90. That is, when the jacket heater 10 is seen in the thickness direction, a part of the second sensor passage hole 12a and a part of the third sensor passage hole 13a may overlap the first sensor passage hole 11a. As a result, The first sensor passage hole 11a, the second sensor passage hole 12a, and the third sensor passage hole 13a may form a single passage hole extending in the thickness direction of the jacket heater 10.

As illustrated in FIG. 2, the sensor 19 extends from the tip 19e of the temperature sensing element 19A, which is located on the inner side of the first heat insulating layer 11, to the outer side of the second heat insulating layer 12 while passing through the first sensor passage hole 11a, the third sensor passage hole 13a, and the second sensor passage hole 12a in the order described here. Passage holes allowing passage of the sensor 19 may also be formed in a member such as the inner cover 16, which is located on the inner side of the first heat insulating layer 11.

As illustrated in FIG. 2, the temperature sensing element 19A may include a first portion 19g located on the inner side of the inner cover 16, a second portion 19h located inside the sensor passage holes 11a, 12a, and 13a, and a third portion 19i located on the outer side of the second heat insulating layer 12. The second portion 19h may be bent from the first portion 19g, and the third portion 19i may be bent from the second portion 19h. The third portion 19i may extend between the second heat insulating layer 12 and the outer cover 17 in the length direction of the pipe 90 or the circumferential direction of the pipe 90. The temperature sensing element 19A may be flexible so as to enable such bending.

As illustrated in FIG. 2, the temperature sensing element 19A and the lead wire 19b may be connected to each other at a position on the outside of the second heat insulating layer 12. The lead wire 19b may extend to the outer side of the jacket heater 10 through the opening 17a formed in the outer cover 17. In the example illustrated in FIG. 2, the lead wire 19b and the lead wire 14b, which extends from the heater wire 14, extend through the common opening 17a to the outer side of the jacket heater 10. However, the lead wire 19b and the lead wire 14b may extend to the outer side of the jacket heater 10 through separate openings.

Further, unlike the example illustrated in FIG. 2, the entire temperature sensing element 19A may be arranged on the inner side of the first heat insulating layer 11. In this case, the lead wire 19b may be passed inside the sensor passage holes 11a, 12a, and 13a.

A size of the third sensor passage hole 13a is larger than a size of each of the first sensor passage hole 11a and the second sensor passage hole 12a. Specifically, as illustrated in FIG. 2, a diameter Ra of the third sensor passage hole 13a is larger than a diameter of each of the first sensor passage hole 11a and the second sensor passage hole 12a. According to this configuration, a position change of the sensor 19 inside the third sensor passage hole 13a is limited by the sensor passage holes 11a and 12a. As a result, contact between the sensor 19 and the reflective layer 13 is prevented. With this configuration, even when the reflective layer 13 is charged, its electricity can be prevented from flowing through the pipe 90 via the sensor 19.

When the sensor passage holes 11a, 12a, and 13a are circular, the size of each of the sensor passage holes 11a, 12a, and 13a may mean the diameter of the passage hole. When the sensor passage holes 11a, 12a, and 13a are rectangular, the size of each of the sensor passage holes 11a, 12a, and 13a may mean a width of one of inner edges of the passage hole.

It is desired that a distance of 3 mm or more be ensured from the inner edges of the passage holes 11a and 12a to the inner edge of the third sensor passage hole 13a. It is further desired to ensure that this distance is 5 mm or more. According to this configuration, contact between the sensor 19 and the reflective layer 13 can be effectively prevented.

Unlike the example illustrated in FIG. 2, the diameter Ra of the third sensor passage hole 13a may be larger than the diameter of one of the first and second sensor through-holes 11a and 12a, but equal to or smaller than the diameter of the other one of the sensor passage hole 11a or 12a. For example, the diameter Ra of the third sensor passage hole 13a may be larger than the diameter of the first sensor passage hole 11a, and may be equal to or smaller than the diameter of the second sensor passage hole 12a. Also in this case, the position change of the sensor 19 inside the third sensor passage hole 13a can be limited by the first sensor passage hole 11a.

The shape of the first sensor passage hole 11a may be, for example, rectangular. In this case, the width of one of the inner edges of the first sensor passage hole 11a may be larger than the width of one of the inner edges of each of the sensor passage holes 11a and 12a.

The diameters of the sensor passage holes 11a and 12a formed in the heat insulating layers 11 and 12 may correspond to the thickness of the sensor 19. That is, the inner surfaces of the heat insulating layers 11 and 12 may be in contact with the sensor 19 (for example, temperature sensing element 19A). According to this configuration, the position change of the sensor 19 inside the third sensor passage hole 13a is more effectively prevented.

The diameter of the first sensor passage hole 11a and the diameter of the second sensor passage hole 12a may be different from each other. For example, the diameter of the first sensor passage hole 11a may correspond to the thickness of the sensor 19, and the inner surface of the first sensor passage hole 11a may be in contact with the sensor 19. Meanwhile, the diameter of the second sensor passage hole 12a may be larger than the thickness of the sensor 19 (diameter of the first sensor passage hole 11a in this case). This can facilitate a process of passing the sensor 19 through the second sensor passage hole 12a. The relationship between the sizes of the sensor passage holes 11a and 12a may be reverse to the example described here.

As illustrated in FIG. 2, the third sensor passage hole 13a may be formed inside the outer peripheral edge of the reflective layer 13. That is, the inner edge of the third sensor passage hole 13a may have an annular shape surrounding a periphery of the sensor 19. Similarly, the first sensor passage hole 11a and the second sensor passage hole 12a may be formed inside the outer peripheral edge of the heat insulating layer 11 and the outer peripheral edge of the heat insulating layer 12, respectively.

Unlike the example illustrated in FIG. 2, the third sensor passage hole 13a may be a recess formed in the outer peripheral edge of the reflective layer 13. Similarly, the first sensor passage hole 11a and the second sensor passage hole 12a may be recesses formed in the outer peripheral edge of the heat insulating layer 11 and the outer peripheral edge of the heat insulating layer 12. The positions of those recesses may be substantially the same in the length direction and the circumferential direction of the pipe 90.

### Sewing Reflective Layer and Heat Insulating Layers Together

The heat insulating layers 11 and 12 and the reflective layer 13 may be sewn together with heat-resistant thread. As the heat-resistant thread, for example, a glass yarn, a silica yarn, an alumina yarn, and even those yarns with fluororesin-coating may be used.

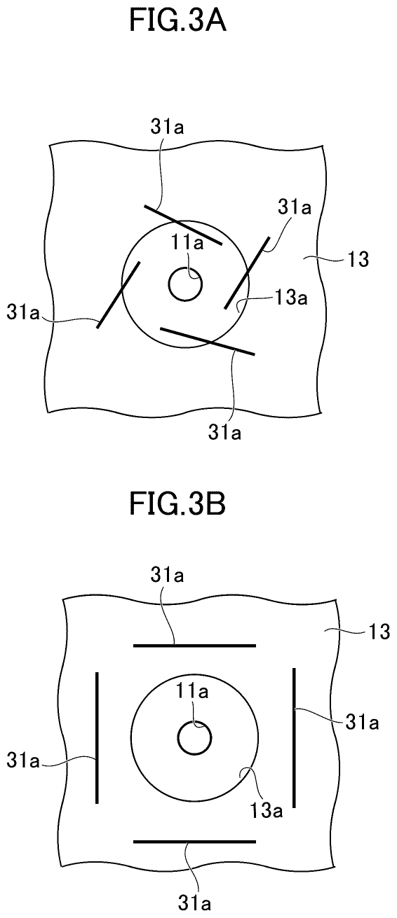

As illustrated in FIG. 3A and FIG. 3B, a periphery of the third sensor passage hole 13a may be surrounded by thread 31a. That is, the reflective layer 13 and the first heat insulating layer 11 may be sewn together with the thread 31a surrounding the third sensor passage hole 13a. According to this configuration, misalignment between the third sensor passage hole 13a and the first sensor passage hole 11a is effectively prevented. As a result, contact between the sensor 19 and the reflective layer 13 is more effectively prevented.

As illustrated in FIG. 3A, the thread 31a may include portions located inside the inner edge of the third sensor passage hole 13a and portions located outside the inner edge of the third sensor passage hole 13a. Unlike this configuration, as illustrated in FIG. 3B, the entire thread 31a surrounding the third sensor passage hole 13a may be located only outside the inner edge of the third sensor passage hole 13a.

The periphery of the third lead wire passage hole 13b, through which the lead wire 14b of the heater wire 14 passes, may also be sewn with the thread 31a as in FIG. 3A and FIG. 3B. That is, the reflective layer 13 and the first heat insulating layer 11 may be sewn together with the thread 31a surrounding the third lead wire passage hole 13b.

The reflective layer 13 may also be sewn onto the first heat insulating layer 11 at other positions with heat-resistant thread. The positions to be sewn may be provided along the outer peripheral edge of the reflective layer 13 so as to surround the entire reflective layer 13, or may be provided only at a plurality of positions inside the outer peripheral edge of the reflective layer 13. Further, the second heat insulating layer 12 may also be sewn onto the first heat insulating layer 11 and the reflective layer 13 with thread. In addition, in order to increase strength of the sewing, the first heat insulating layer 11 and the reflective layer 13 may also be sewn with thread onto the heater wire base material 18, onto which the heater wire 14 is sewn, and to the inner cover 16.

### Common Passage Hole

The structure of each of the lead wire passage holes 11b to 13b and each of the sensor passage holes 11a to 13a is not limited to the example illustrated in FIG. 2 and the like.

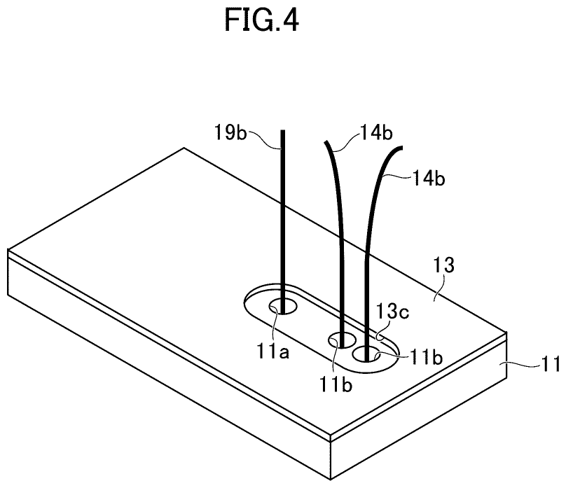

FIG. 4 is a view for illustrating a modification example of the passage holes. In the example illustrated in FIG. 4, a lead wire passage hole 13c is formed in the reflective layer 13. When the jacket heater 10 is seen in plan view (when the passage hole 13c is seen in the radial direction of the pipe 90), the sensor passage holes 11a and 12a and the lead wire passage holes 11b and 12b described above are located inside the lead wire passage hole 13c. Therefore, each lead wire 14b of the heater wire 14 passes through the lead wire passage holes 11b and 12b and the lead wire passage hole 13c to extend to the outer side of the heat insulating layer 12. Further, the sensor 19 passes through the sensor passage holes 11a and 12a and the lead wire passage hole 13c to extend to the outer side of the heat insulating layer 12. According to this structure, the number of passage holes formed in the reflective layer 13 can be reduced. As a result, steps of manufacturing the reflective layer 13 can be reduced.

A size of the lead wire passage hole 13c is larger than the sizes of the sensor passage holes 11a and 12a and the sizes of the lead wire passage holes 11b and 12b. For example, it is desired that a distance of 3 mm or more be ensured from an inner edge of the lead wire passage hole 13c to the inner edges of the passage holes 11a, 12a, 11b, and 12b. As this distance, a distance of 5 mm or more may preferably be ensured. This prevents contact between the lead wires 14b and the reflective layer 13. For example, even when the outer sheath of the lead wire 14b is broken, the reflective layer 13 can be prevented from being charged due to the electricity flowing from the lead wire 14b to the reflective layer 13. Further, contact between the sensor 19 and the reflective layer 13 is prevented. With this configuration, even when the reflective layer 13 is charged, its electricity is prevented from flowing through the pipe 90 via the sensor 19.

### Thermostat

As illustrated in FIG. 2, the jacket heater 10 may include a thermostat 21. The thermostat 21 may be connected to the heater wire 14 through a lead wire (not shown), or may be connected to the external power supply (controller that supplies a current to the heater wire 14). The thermostat 21 turns off when the thermostat 21 detects excessive temperature rise of the heater wire 14, and stops the current to the heater wire 14.

As illustrated in FIG. 2, an accommodating chamber 12d for accommodating the thermostat 21 may be formed in the second heat insulating layer 12. The thermostat 21 may be disposed on the outside of the reflective layer 13. According to this arrangement of the thermostat 21, the temperature of the thermostat 21 is lower than the temperature of the inner surface of the jacket heater 10 on which the heater wire 14 is arranged, and the temperature of the pipe 90. As a result, even when the output of the jacket heater 10 is required to be increased in order to raise the temperature of the pipe 90, a small-sized thermostat with a lower operating temperature (temperature at which the current is interrupted) can be used as the thermostat 21 that prevents excessive temperature rise of the jacket heater 10. For example, when the temperature of the pipe rises to 300 °C due to heating of the jacket heater, a large-sized thermostat with an operating temperature set at 300 °C or higher is usually required as a thermostat. However, in the jacket heater 10 proposed in the present disclosure, because the thermostat 21 is arranged on the outside of the reflective layer 13, the temperature around the thermostat 21 does not reach 300 °C. Accordingly, a thermostat with an operating temperature lower than 300 °C (for example, a small-sized thermostat with an operating temperature of about 200 °C) can be used as the thermostat 21, and the pipe 90 can be heated to a temperature sufficiently higher than its operating temperature (300 °C in the example described here).

Unlike the example illustrated in FIG. 2, the thermostat 21 may be disposed on the inside of the reflective layer 13.

### Method of Manufacturing Jacket Heater

An example of a method of manufacturing the jacket heater 10 will be described. A worker prepares the first heat insulating layer 11 and the second heat insulating layer 12. The worker forms the first lead wire passage hole 11b and the first sensor passage hole 11a in the first heat insulating layer 11, and forms the second lead wire passage hole 12b and the second sensor passage hole 12a in the second heat insulating layer 12. Further, the worker prepares the reflective layer 13, and forms the third lead wire passage hole 13b and the third sensor passage hole 13a in the reflective layer 13. At this time, the lead wire passage hole 13c may be formed in the reflective layer 13 as illustrated in FIG. 4.

The worker sews the first heat insulating layer 11, the reflective layer 13, and the second heat insulating layer 12 together with the heat-resistant thread 31a. At this time, the worker may sew the first heat insulating layer 11 and the reflective layer 13 together, and then sew the second heat insulating layer 12 onto the first heat insulating layer 11 and the reflective layer 13. As another example, the worker may sew the first heat insulating layer 11, the reflective layer 13, and the second heat insulating layer 12 together. Further, the worker sews the heater wire 14 onto the heater wire base material 18. At this time, the worker may sew the insulation layer 15 onto the heater wire 14 and the heater wire base material 18.

Next, the worker draws the lead wire 14b of the heater wire 14 through the lead wire passage holes 11b, 12b, and 13b to the outer side of the second heat insulating layer 12. Next, the worker covers the inner side of the heater wire 14, the insulation layer 15, and the heater wire base material 18 with the inner cover 16. Then, the worker draws the sensor 19 through holes formed in the inner cover 16, the insulation layer 15, and the heater wire base material 18, and further draws the sensor 19 through the sensor passage holes 11a, 13a, and 12a to the outer side of the second heat insulating layer 12. Then, the worker covers the outside of the second heat insulating layer 12 with the outer cover 17, and draws the lead wires 14b and 19b to the outer side of the jacket heater 10 through the opening 17a formed in the outer cover 17. Then, the worker sews the inner cover 16 and the outer cover 17 together, and accommodates the heater wire 14, the first heat insulating layer 11, and the like. within the inner cover 16 and the outer cover 17.

### Summary

(1) The jacket heater 10 includes: the first heat insulating layer 11; the reflective layer 13 arranged on the outside of the first heat insulating layer 11; the second heat insulating layer 12 arranged on the outside of the reflective layer 13; and the heater wire 14 arranged on the inner side of the first heat insulating layer 11. This jacket heater 10 includes the reflective layer 13, and hence while power consumption in the jacket heater is reduced, the pipe 90 can be sufficiently heated. Further, since the second heat insulating layer 12 is provided on the outside of the reflective layer 13, the outer surface of the jacket heater 10 can be lowered to an appropriate temperature. As a result, workability around the jacket heater 10 can be improved.
(2) In the structure of the item (1), the lead wire 14b may be connected to the heater wire 14. The first lead wire passage hole 11b may be formed in the first heat insulating layer 11, the second lead wire passage hole 12b may be formed in the second heat insulating layer 12, and the third lead wire passage hole 13b (or passage hole 13c, FIG. 4) may be formed in the reflective layer 13. The lead wire 14b may pass through the first lead wire passage hole 11b, the third lead wire passage hole 13b (or passage hole 13c), and the second lead wire passage hole 12b to extend to the outer side of the second heat insulating layer 12. The size of the third lead wire passage hole 13b (or passage hole 13c) may be larger than the size of at least one of the first lead wire passage hole 11b or the second lead wire passage hole 12b. According to this structure, the lead wire 14b connected to the heater wire 14 is prevented from coming into contact with the reflective layer 13 having conductivity. As a result, the reflective layer 13 can be prevented from being charged.
(3) In the structure of the item (1) or (2), the jacket heater 10 may include the sensor 19 having a temperature sensing element 19A, at least a tip 19e of which is located on the inner side of the first heat insulating layer 11. A first sensor passage hole 11a may be formed in the first heat insulating layer 11, the second sensor passage hole 12a may be formed in the second heat insulating layer 12, and the third sensor passage hole 13a (or passage hole 13c, FIG. 4) may be formed in the reflective layer 13. The sensor 19 may extend from the tip 19e through the first sensor passage hole 11a, the third sensor passage hole 13a (or passage hole 13c), and the second sensor passage hole 12a to the outer side of the second heat insulating layer 12. The size of the third sensor passage hole 13a (or passage hole 13c) may be larger than the size of at least one of the first sensor passage hole 11a or the second sensor passage hole 12a. According to this structure, the sensor 19 is prevented from coming into contact with the reflective layer 13 having conductivity. As a result, even when the reflective layer 13 is charged, its electricity is prevented from flowing through the pipe via the sensor 19.
(4) In the structure of the item (2), the jacket heater 10 may include the sensor 19 having a temperature sensing element 19A, at least a tip 19e of which is located on the inner side of the first heat insulating layer 11. The first sensor passage hole 11a may be formed in the first heat insulating layer 11, and the second sensor passage hole 12a may be formed in the second heat insulating layer 12. The sensor 19 may extend from the tip 19e through the first sensor passage hole 11a, the lead wire passage hole 13c (see FIG. 4), and the second sensor passage hole 12a to the outer side of the second heat insulating layer 12. According to this structure, since the sensor 19 and the lead wire 14b pass through the same passage hole 13c, the number of passage holes formed in the reflective layer 13 is reduced. As a result, steps of manufacturing the reflective layer 13 can be reduced.
(5) In the structure of the item (2), the size of at least one of the first lead wire passage hole 11b or the second lead wire passage hole 12b may correspond to the thickness of the lead wire 14b. According to this structure, the position change of the lead wire 14b inside the third lead wire passage hole 13b is more effectively prevented. As a result, contact between the reflective layer 13 and the lead wire 14b is more effectively prevented.
(6) In the structure of the item (3), the size of at least one of the first sensor passage hole 11a or the second sensor passage hole 12a may correspond to the thickness of the sensor 19. According to this structure, the position change of the sensor 19 inside the third sensor passage hole 13a is more effectively prevented. As a result, contact between the reflective layer 13 and the sensor 19 is more effectively prevented.
(7) In the structure of the item (2) or (5), the first heat insulating layer 11 and the reflective layer 13 may be sewn together with the heat-resistant thread 31a (FIG. 3A and FIG. 3B). The thread 31a may surround the periphery of the third lead wire passage hole 13b. According to this structure, the relative misalignment between the third lead wire passage hole 13b and the lead wire passage holes 11b and 12b is prevented. As a result, contact between the reflective layer 13 and the lead wire 14b is more effectively prevented.
(8) In the structure of the item (3) or (6), the first heat insulating layer 11 and the reflective layer 13 may be sewn together with the heat-resistant thread 31a (FIG. 3A and FIG. 3B). The thread 31a may surround the periphery of the third sensor passage hole 13a. According to this structure, the relative misalignment between the third sensor passage hole 13a and the sensor passage holes 11a and 12a is prevented. As a result, contact between the reflective layer 13 and the lead wire 14b is more effectively prevented.
(9) The method of manufacturing the jacket heater 10 configured to be mounted to the outer periphery of the pipe 90 includes: sewing together the first heat insulating layer 11 for covering the heater wire 14, the reflective layer 13 for covering the outside of the first heat insulating layer 11, and the second heat insulating layer 12 for covering the outside of the reflective layer 13; and sewing the heater wire 14 onto the first heat insulating layer 11.
(10) A heat insulating structure, which is configured to be mounted to the outer periphery of the pipe 90, includes: the first heat insulating layer 11; the reflective layer 13 arranged on the outside of the first heat insulating layer 11; the second heat insulating layer 12 arranged on the outside of the reflective layer 13; and the heater wire 14 arranged on the inner side of the first heat insulating layer 11.

The jacket heater proposed in the present disclosure is not limited to the examples described above, but may be modified in various ways. For example, the jacket heater may have a plurality of heat insulating structures, and each heat insulating structure may include the first heat insulating layer 11, the reflective layer 13, and the second heat insulating layer 12.

1-10. (canceled)

11. A jacket heater, which is configured to be mounted to an outer periphery of a pipe, the jacket heater comprising:
a first heat insulating layer;
a reflective layer arranged on an outside of the first heat insulating layer;
a second heat insulating layer arranged on an outside of the reflective layer; and
a heater wire arranged on an inner side of the first heat insulating layer.

12. The jacket heater according to claim 11, wherein
a lead wire is connected to the heater wire,
a first lead wire passage hole is formed in the first heat insulating layer,
a second lead wire passage hole is formed in the second heat insulating layer,
a third lead wire passage hole is formed in the reflective layer,
the reflective layer has conductivity,
the lead wire passes through the first lead wire passage hole, the third lead wire passage hole, and the second lead wire passage hole to extend to an outer side of the second heat insulating layer, and
a size of the third lead wire passage hole is larger than a size of at least one of the first lead wire passage hole or the second lead wire passage hole.

13. The jacket heater according to claim 11, further comprising a sensor including a temperature sensing element in which at least a tip of the temperature sensing element is located on an inner side of the first heat insulating layer, wherein
a first sensor passage hole is formed in the first heat insulating layer,
a second sensor passage hole is formed in the second heat insulating layer,
a third sensor passage hole is formed in the reflective layer,
the reflective layer has conductivity,
the sensor extends from the tip to the outer side of the second heat insulating layer through the first sensor passage hole, the third sensor passage hole, and the second sensor passage hole, and
a size of the third sensor passage hole is larger than a size of at least one of the first sensor passage hole or the second sensor passage hole.

14. The jacket heater according to claim 12, further comprising a sensor including a temperature sensing element in which at least a tip of the temperature sensing element is located on an inner side of the first heat insulating layer, wherein
a first sensor passage hole is formed in the first heat insulating layer,
a second sensor passage hole is formed in the second heat insulating layer,
a third sensor passage hole is formed in the reflective layer,
the reflective layer has conductivity,
the sensor extends from the tip to the outer side of the second heat insulating layer through the first sensor passage hole, the third sensor passage hole, and the second sensor passage hole, and
a size of the third sensor passage hole is larger than a size of at least one of the first sensor passage hole or the second sensor passage hole.

15. The jacket heater according to claim 12, further comprising a sensor including a temperature sensing element in which at least a tip of the temperature sensing element is located on an inner side of the first heat insulating layer, wherein
a first sensor passage hole is formed in the first heat insulating layer,
a second sensor passage hole is formed in the second heat insulating layer, and
the sensor extends from the tip to the outer side of the second heat insulating layer through the first sensor passage hole, the third lead wire passage hole, and the second sensor passage hole.

16. The jacket heater according to claim 12, wherein the size of at least one of the first lead wire passage hole or the second lead wire passage hole corresponds to a thickness of the lead wire.

17. The jacket heater according to claim 13, wherein the size of at least one of the first sensor passage hole or the second sensor passage hole corresponds to a thickness of the sensor.

18. The jacket heater according to claim 12, wherein
the first heat insulating layer and the reflective layer are sewn together with heat-resistant thread, and
the thread surrounds a periphery of the third lead wire passage hole.

19. The jacket heater according to claim 16, wherein
the first heat insulating layer and the reflective layer are sewn together with heat-resistant thread, and
the thread surrounds a periphery of the third lead wire passage hole.

20. The jacket heater according to claim 13, wherein
the first heat insulating layer and the reflective layer are sewn together with heat-resistant thread, and
the thread surrounds a periphery of the third sensor passage hole.

21. The jacket heater according to claim 17, wherein
the first heat insulating layer and the reflective layer are sewn together with heat-resistant thread, and
the thread surrounds a periphery of the third sensor passage hole.

22. A method of manufacturing a jacket heater configured to be mounted to an outer periphery of a pipe, the method comprising:
sewing together a first heat insulating layer for covering a heater wire, a reflective layer for covering an outside of the first heat insulating layer, and a second heat insulating layer for covering an outside of the reflective layer; and
sewing the heater wire onto the first heat insulating layer.

23. A heat insulating structure, which is configured to be mounted to an outer periphery of a pipe, the heat insulating structure comprising:
a first heat insulating layer;
a reflective layer arranged on an outside of the first heat insulating layer;
a second heat insulating layer arranged on an outside of the reflective layer; and
a heater wire arranged on an inner side of the first heat insulating layer.
